(19) United States
(12) Patent Application Publication
(10) Pub. No.: US 2015/0063852 A1
(43) Pub. Date: Mar. 5, 2015

(54) IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventor: Hiroshi Ota, Ota-ku (JP)

(21) Appl. No.: 14/445,350

(22) Filed: Jul. 29, 2014

(30) Foreign Application Priority Data
Sep. 5, 2013 (JP) 2013-184510

(51) Int. Cl. G03G 15/20

(52) U.S. Cl. CPC G03G 15/2039
USPC 399/69

(57) ABSTRACT

An image forming apparatus includes an image forming unit configured to form a toner image on a recording medium, a heating unit and a pressurizing unit provided in a fixing unit, a first heater, a second heater, and a control unit configured to alternately repeat a heating state and a non-heating state for the respective heaters and heat the heating unit. The control unit alternately subjects the first and second heaters to heating control such that any one of the first and second heaters is in the heated state, if a predetermined condition holds, sets a heating time of at least one heater shorter than a heating time during the alternate heating control and controls the first and second heaters such that any one of the first and second heaters is in the heating state or both of the first and second heaters are in the non-heating state.

### CROSS-REFERENCE TO RELATED APPLICATION

This application is based upon and claims the benefit of priority from Japanese Patent Application No. 2013-184510, filed Sep. 5, 2013, the entire contents of which are incorporated herein by reference.

### FIELD

Embodiments described herein relate generally to an image forming apparatus.

### BACKGROUND

An image forming apparatus (MFP: Multi-Functional Peripheral) forms a visible image corresponding to image data using, for example, a toner serving as a visualizing material and outputs the visible image onto a recording medium as an output image. A fixing device heats and pressurizes the recording medium, on which a toner image is formed, to integrate the toner with the recording medium.

The related art is disclosed in JP-A-7-114289 and JP-A-2006-119431.

As demanded by a power saving program “Energy Star” promoted by the American Environmental Protection Agency (EPA), a “Blue Angel” scheme operated by the German Federal Environmental Agency, and the like, a reduction in power consumption is further demanded in image forming apparatuses.

On the other hand, in power consumption in an image forming apparatus, power consumption of a fixing device accounts for large percentage. Therefore, there is an increasing need for a reduction of the power consumption in the fixing device.

### BRIEF DESCRIPTION OF THE DRAWINGS

FIG. 1 is a diagram showing the configuration of an image forming apparatus according to an embodiment;

FIG. 2 is a diagram showing the configuration of a control unit in the image forming apparatus;

FIG. 3 is a sectional view showing the configuration of a fixing unit in the image forming apparatus;

FIG. 4 is a diagram showing a cross section of a heating roller and a pressurizing roller in the fixing unit;

FIG. 5 is a diagram showing another configuration of a heating and pressurizing mechanism of the fixing unit;

FIG. 6 is a diagram showing another configuration of the heating and pressurizing mechanism of the fixing unit;

FIG. 7 is a diagram showing a fixing temperature region specified by a heating roller temperature and a pressurizing roller temperature in the image forming apparatus;

FIG. 8 is a diagram for explaining temperature control start timing in the image forming apparatus;

FIGS. 9A and 9B are diagrams for explaining a heater lamp lighting control method in the image forming apparatus; and

FIG. 10 is a flowchart for explaining a heater lamp lighting control procedure in the image forming apparatus.

### DETAILED DESCRIPTION

An embodiment has been devised in view of such circumstances and it is an object of the embodiment to provide an image forming apparatus that can further reduce power consumption in a fixing device.

According to an embodiment for solving the problem, there is provided an image forming apparatus including: an image forming unit configured to form a toner image on a recording medium; a heating unit and a pressurizing unit functioning as heating and pressurizing members provided in a fixing unit; a first heater provided on the inside of the heating unit and configured to heat the center of the heating unit; a second heater provided on the inside of the heating unit and configured to heat a peripheral section of the heating unit; and a control unit configured to alternately repeat a heating state and a non-heating state for the respective heaters and heat the heating unit. The control unit alternately subjects the first and second heaters to heating control such that any one of the first and second heaters is in the heated state and, if a predetermined condition holds, sets a heating time of at least one heater shorter than a heating time during the alternate heating control and controls the first and second heaters such that any one of the first and second heaters is in the heating state or both of the first and second heaters are in the non-heating state.

An embodiment is explained below with reference to the drawings.

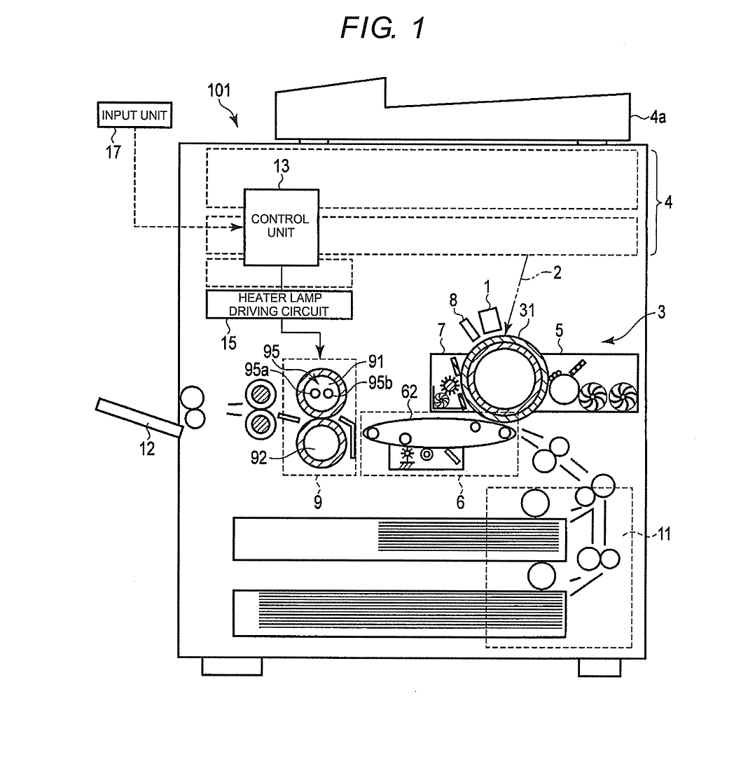

FIG. 1 is a diagram showing the configuration of an image forming apparatus in this embodiment.

An image forming apparatus 101 includes a charging unit 1, a writing unit 2, an image forming unit 3, a document reading unit 4, a developing unit 5, a transfer unit 6, a cleaning unit 7, a charge removing unit 8, and a fixing unit 9.

The document reading unit 4 includes, for example, a CCD sensor of 600 dpi (dot per inch)/7500 pixels and converts image information acquired as a reflected light signal of light radiated on an original document into an electric signal.

The charging unit 1 gives charges having a predetermined polarity to the surface of an image bearing member (e.g., a cylindrical photoconductive drum 31 described below) provided in the image forming unit 3. The image bearing member is not limited to the cylindrical photoconductive drum 31 and may be an endless belt or may be an endless belt, on the inner side of which a cylindrical member is arranged.

The writing unit 2 radiates a laser beam on a photoconductive layer on the surface of the photoconductive drum 31 in which the charging unit 1 is charged and changes the potential of the photoconductive layer. The intensity of the laser beam changes according to information concerning an image to be formed. A latent image is formed in a portion of the photoconductive layer where the potential is changed. The photoconductive drum 31 has an outer diameter of, for example, 100 mm and includes a photoconductive layer on the surface of a metal base (hollow aluminum). The photoconductive layer includes, for example, an organic photoconductor (OPC).

In the image forming unit 3, the developing unit 5, the transfer unit 6, the cleaning unit 7, and the charge removing unit 8 are provided. The photoconductive drum 31 rotates, for example, clockwise at predetermined speed. According to the rotation of the photoconductive drum 31, the latent image on the photoconductive drum 31 is carried to the developing unit 5, the transfer unit 6, the cleaning unit 7, and the charge removing unit 8.

The developing unit 5 supplies toner to the photoconductive drum 31 and changes the latent image to a visualized toner image. The developing unit 5 includes a magnet roller (not shown in the figure) and a developing sleeve (not shown in the figure). The magnet roller selectively provides the toner to the latent image on the surface of the photoconductive drum 31 while attracting, with magnetism, the toner moving according to the rotation of the developing sleeve. An interval between the developing sleeve and the photoconductive drum 31 is determined by a guide roller that is in contact with the photoconductive drum surface. The developing sleeve is formed of a nonmagnetic material, for example, stainless steel or aluminum.

In the transfer unit 6, a sheet conveying belt and a transfer roller are provided. The sheet conveying belts is an endless belt and conveys a sheet (a recording medium) fed from a paper feeding unit 11 explained below. A predetermined voltage is applied to the transfer roller. With an electric field of the transfer roller, the toner image moves to the sheet conveyed by the sheet conveying belt.

The cleaning unit 7 stores, in a waste toner and foreign matter storing section, transfer residual toner scraped off by a removing mechanism (e.g., a brush body) and foreign matters conveyed together with the sheet such as fiber pieces of the sheet and a surface coat agent.

The charge removing unit 8 removes residual charges on the surface of the photoconductive drum 31 and returns the potential of the photoconductive layer to an initial state before the charging of the charging unit 1. The charge removing unit 8 includes an LED array in which LED elements that emit, for example, red light having a wavelength longer than 770 nm are arranged in the axis direction of the photoconductive drum 31.

The image forming apparatus 101 further includes a paper feeding unit 11 that feeds the sheet to the transfer unit 6 of the image forming unit 3, the fixing unit 9 that fixes the sheet on which the toner image is transferred, and a paper discharging unit 12 that receives the sheet on which the toner image is fixed by the fixing unit 9.

The image forming apparatus 101 can form a toner image corresponding to not only image information read by the document reading unit 4 but also image information provided by a not-shown external apparatus such as a PC (personal computer) or a (FAX) facsimile.

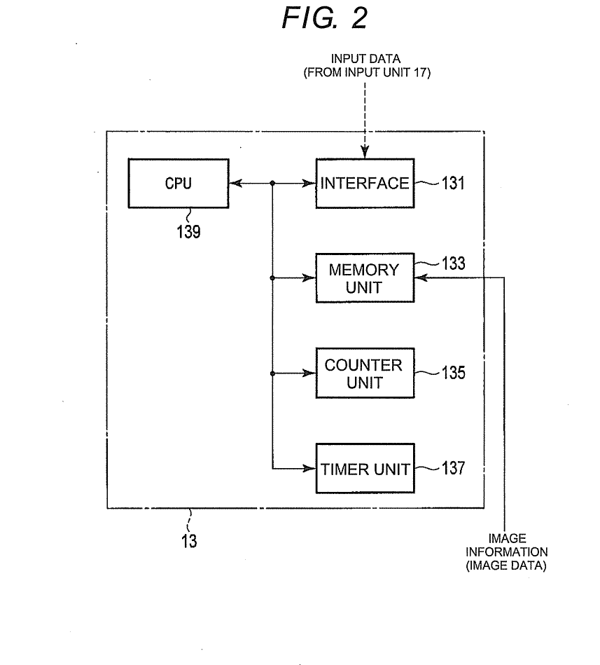

FIG. 2 is a diagram showing the configuration of a control unit in the image forming apparatus.

A control unit 13 includes an interface 131, a memory unit 133, a counter unit 135, a timer unit 137, and a central processing unit (CPU) 139.

The interface 131 receives input data from an input unit 17 on the outside. The input data includes the number of output images corresponding to image information, an output image magnification, a size of a recording medium, and a print start operation input. The memory unit 133 retains input numerical value data, image information, and the like. The counter unit 135 counts the number of image outputs. The timer unit 137 measures time necessary for the operation of the image forming apparatus 101. The CPU 139 collectively controls the operation of the image forming apparatus 101.

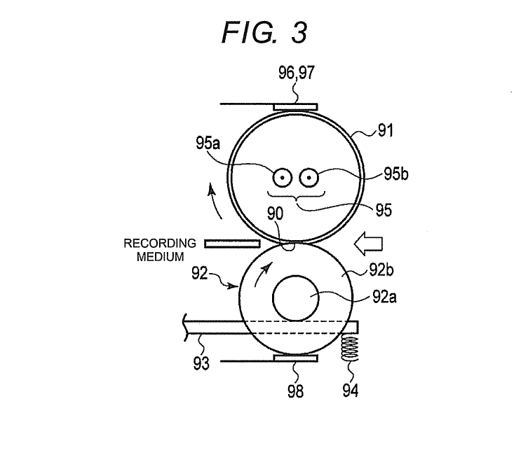

FIG. 3 is a sectional view showing the configuration of the fixing unit in the image forming apparatus.

The fixing unit 9 includes a heating roller 91 and a pressurizing roller 92 that provide a nip region 90, to which at least one of the heating roller 91 and the pressurizing roller 92 is elastically deformed to adhere. A pressure is applied by a spring 94 to a roller supporting body 93 that supports the heating roller 91 or the pressurizing roller 92. The outer circumferential surface of one roller comes into contact with the outer circumferential surface of the other roller.

The diameter of the heating roller 91 is φ30 mm. The heating roller 91 is formed of aluminum having thickness of 0.8 mm. The roller surface of the heating roller 91 includes a release layer of fluorocarbon resin (tetrafluoroethylene resin) or the like. The diameter of the pressurizing roller 92 is φ30 mm. The pressurizing roller 92 includes an elastic layer 92b of silicon rubber, fluorocarbon rubber, or the like around a cored bar 92a.

A heating device 95 is provided on the inside of the heating roller 91. The heating device 95 includes a heater lamp, for example, a halogen lamp in a heating source.

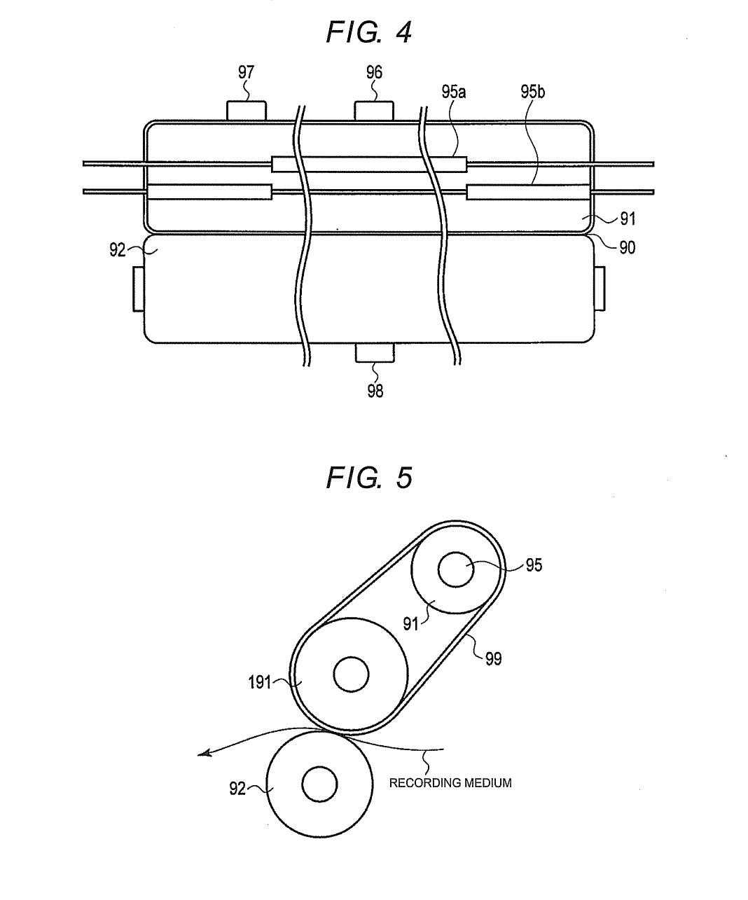

FIG. 4 is a diagram showing a cross section of the heating roller 91 and the pressurizing roller 92 in the fixing unit of the image forming apparatus.

In the heating roller 91, two heater lamps 95a and 95b are arranged. That is, the heating roller 91 includes a center lamp 95a that heats the center and two divided heater lamps of a side lamp 95b that heats peripheral sections. The lamps 95a and 95b are respectively lit at predetermined timings by a heater lamp driving circuit 15. The predetermined timings are explained below. Power consumption of each of the heater lamps 95a and 95b is 600 W.

In the center and the peripheral section in the longitudinal direction of the hating roller 91, temperature sensors (thermistors) 96 and 97 that detect the temperature on the heating roller surface are respectively provided. In the center in the longitudinal direction of the pressurizing roller 92, a temperature sensor (a thermistor) 98 is provided.

The heating and pressuring mechanism of the fixing unit is not limited to the configurations shown in FIGS. 3 and 4.

For example, as shown in FIG. 5, a configuration is also possible in which a belt body 99 that is in contact with the pressurizing roller 92 and a belt roller 191 that forms a nip between the pressurizing roller 92 and the belt body 99 are used and the heating roller 91 is not in direct contact with the pressurizing roller 92. In this case, the heating device 95 can be located on the outer circumference side of the belt body 99 as well.

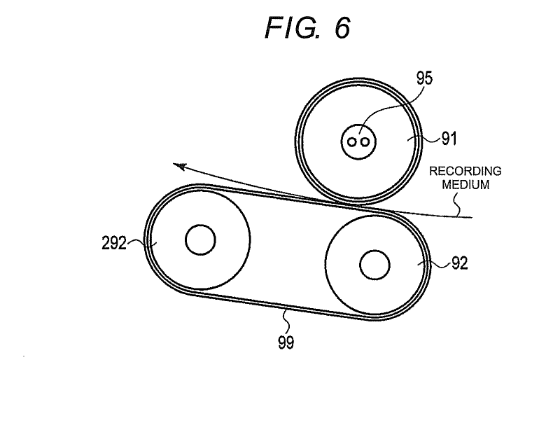

As shown in FIG. 6, a configuration is also possible in which the belt body 99 that is in contact with the heating roller 91 and a belt roller 292 that forms a nip between the heating roller 91 and the belt body 99 are used and the pressurizing roller 92 is not in direct contact with the heating roller 91.

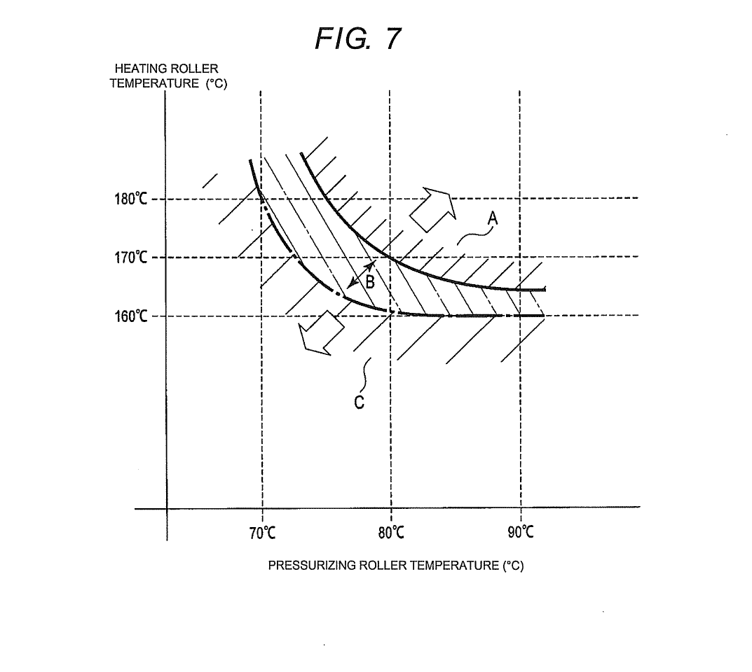

FIG. 7 is a diagram showing a fixing temperature region specified by a heating roller temperature and a pressurizing roller temperature in the image forming apparatus.

In FIG. 7, if the temperatures of the heating roller 91 and the pressurizing roller 92 are within a satisfactory fixing region indicated by a sign A, an image defect such as a fixing failure does not occur. In FIG. 7, a region indicated by a sign B represents a temperature region in which the fixing failure could occur under specific conditions. For example, in image formation on a recording medium thicker than 100 g/cm² or a full-color image output with a thick toner layer, it is preferable to use the temperatures in the temperature region indicated by the sign A as the temperatures of the heating roller 91 and the pressurizing roller 92.

A lighting control method for the heater lamps in the image forming apparatus is explained.

In the image forming apparatus in the past, a heating temperature by heater lamps during printing is set rather high to prevent a fixing failure from occurring. That is, in the image forming apparatus in the past, during the printing, even if a recording medium having largest thickness (or basis weight) and a largest size is subjected to fixing, the heating temperature is set to temperature for not causing a fixing failure due to insufficient heating.

Therefore, during the printing, depending on thickness (or basis weight) and a size of a recording medium, the temperature of the heating roller 91 can be controlled to temperature lower than the temperature in the past. However, if the temperature of the heating roller 91 is controlled to such low temperature, likelihood of occurrence of a fixing failure due to insufficient heating increases. Therefore, a temperature control method for not causing a fixing failure is necessary.

### Temperature Control Start Timing

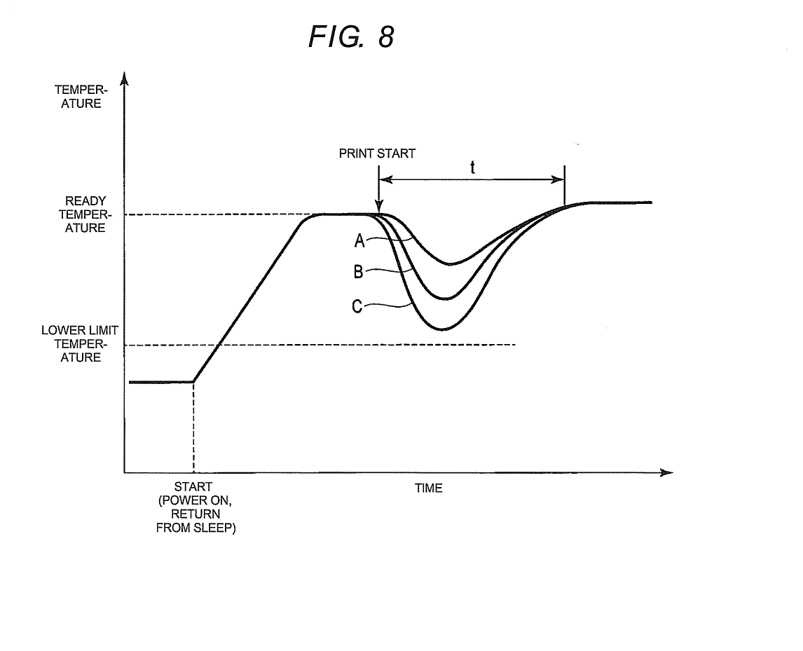

FIG. 8 is a diagram for explaining temperature control start timing in the image forming apparatus. In a coordinate shown in FIG. 8, the ordinate indicates the temperature of the heating roller 91 and the abscissa indicates time.

In the past, for example, if a power supply of the image forming apparatus 101 is turned on or if the image forming apparatus 101 returns from a sleep mode, the image forming apparatus 101 executes a warm-up operation for heating the fixing unit 9 to a predetermined fixing temperature before starting an image forming operation. The fixing temperature is temperature for making it possible to surely fix an image irrespective of thickness, a size, and the like of a recording medium.

If the warm-up is started, since the heater lamps 95a and 95b are lit, the temperature of the heating roller 91 rises. If the temperature of the heating roller 91 reaches a ready temperature, the image forming apparatus 101 changes to a standby state. If a print operation is started by operation by a user, a toner image is transferred onto a recording medium and the recording medium is conveyed to the fixing unit 9.

In the fixing unit 9, the recording medium is heated and pressurized by the heating roller 91 and the pressurizing roller 92 and fixing is performed. At this point, a heat quantity for heating the recording medium is released and the temperature of the heating roller 91 falls. The falling temperature is different depending on thickness, a size, and the like of the recording medium. In FIG. 8, the difference in the falling temperature is indicated by temperature fall characteristic curves A, B, and C. In this case, if the temperature falls below a lower limit temperature, a fixing failure occurs. If the temperature sensors 96 and 97 detect that the temperature of the heating roller 91 falls below a setting temperature because of the heat release, the control unit 13 lights the heater lamps 95a and 95b via the heater lamp driving circuit 15. Consequently, the temperature of the heating roller 91 rises. If the temperature of the heating roller 91 reaches a predetermined temperature higher than the ready temperature, the control unit 13 extinguishes the heater lamps 95a and 95b. Thereafter, until the print operation ends, the control unit 13 executes ON and OFF control for controlling the temperature of the heating roller 91 according to lighting and extinction of the heater lamps 95a and 95b.

The temperature fall of the heating roller 91 due to the recording medium is the largest during the fixing operation for a first sheet and decreases every time a second sheet, a third sheet, and subsequent sheets are processed. This is because the temperature of the fixing unit 9 including the heating roller 91 and the pressurizing roller 92 is the lowest during a fixing start.

From the examination result explained above, even if the temperature of the heating roller 91 is continuously controlled to a temperature value lower than a temperature value in the past, it is necessary that the temperature of the heating roller 91 does not fall below the lower limit temperature due to the recording medium.

Control start timings that satisfy this condition are the following timings when the heating roller 91 recovers from the temperature fall due to the recording medium:

(1) timing when a predetermined time (t) elapses after a print start;
(2) timing when the predetermined time (t) elapses after the print start and the temperature of the heating roller 91 is equal to or higher than a predetermined temperature;
(3) timing when a predetermined number of recording media are subjected to the fixing after the print start; and
(4) combined timing of (1) to (3).

### Heater Lamp Lighting Control Method

As explained above, after the print operation is started, the ON and OFF control for controlling the lighting and the extinction of the heater lamps is executed on the basis of the temperature of the heating roller 91.

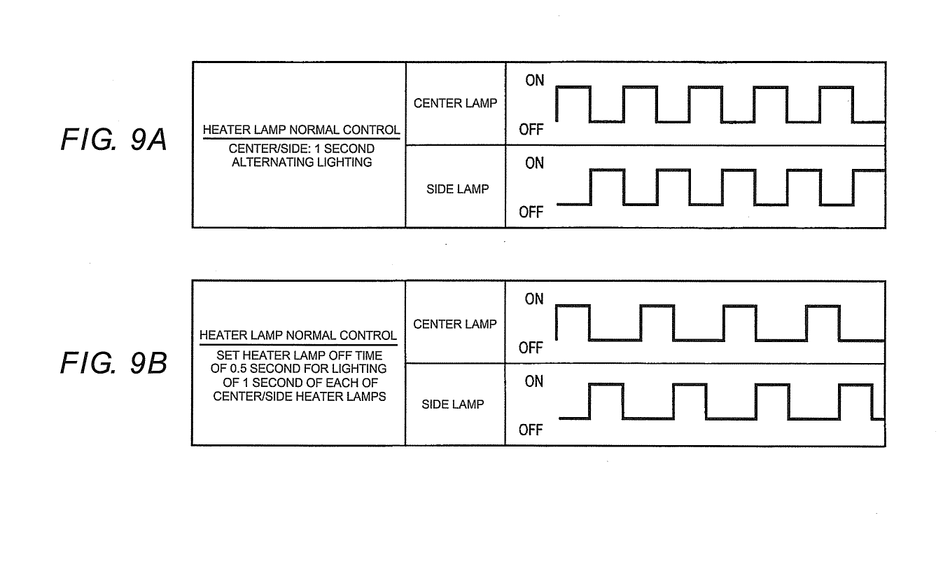

FIGS. 9A and 9B are diagrams for explaining a heater lamp lighting control method in the image forming apparatus. FIG. 9A shows a heater lamp lighting control method in the past. FIG. 9B shows a heater lamp lighting control method in this embodiment.

In the heater lamp lighting control method in the past shown in FIG. 9A, the center lamp 95a and the side lamp 95b are alternately lit at every one second. Therefore, during the heater lamp lighting, any one of the center lamp 95a and the side lamp 95b is always lit. Power consumption at this point is always 600 W.

In the heater lamp lighting control method in this embodiment shown in FIG. 2B, each of the center lamp 95a and the side lamp 95b is lit for one second and extinguished for 1.5 seconds. If the center lamp 95a is extinguished, the side lamp 95b is lit. Therefore, in the lighting control method, there is a time period of 0.5 second in which both the lamps are not lit in the period of 2.5 seconds. As a result, power consumption in this embodiment is 80% (=(2.5−0.5)/2.5) of the power consumption in the past.

The embodiment is not limited to the form shown in FIG. 9B. That is, the lighting of the side lamp 95b does not need to be performed at the extinguishing timing of the center lamp 95a. Under a condition that the center lamp 95a and the side lamp 95b are not simultaneously lit, provision of a time period in which both the lamps are not lit only has to be realized.

According to the control method for providing the time period in which both the lamps are not lit, it is possible to easily control a reduction rate of power consumption simply by changing extinguishing times of the respective lamps. Therefore, it is possible to attain an appropriate reduction in electric power while flexibly coping with the specifications of the image forming apparatus 101.

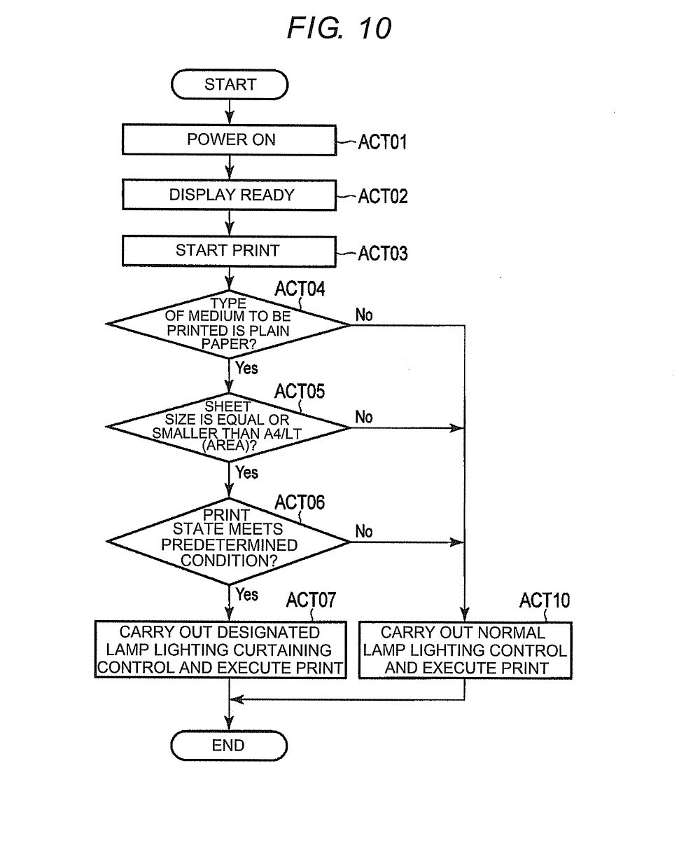

FIG. 10 is a flowchart for explaining a heater lamp lighting control procedure in the image forming apparatus.

In ACT 01, if the power supply of the image forming apparatus 101 is turned on or if the image forming apparatus 101 returns from the sleep mode, the control unit 13 executes the warm-up operation for heating the fixing unit 9 to the predetermined fixing temperature. In ACT 02, if the warm-up ends, the control unit 13 displays “ready” on a control panel (not shown in the figure) of the image forming apparatus 101 and stands by for operation by the user.

In ACT 03, if the user sets conditions for print from the control panel and operates a start button, the control unit 13 starts the print operation.

In ACT 04, the control unit 13 checks whether a recording medium to be printed is plain paper. In the image forming apparatus 101, recording media are classified into plain paper and thick paper according to thickness (or basis weight). Therefore, the control unit 13 checks whether the recording medium is the plain paper according to setting by the user or a sensor provided in the paper feeding unit 11.

If the recording medium is not the plain paper (NO in ACT 04), that is, if the recording medium is the thick paper, it is likely that a fixing temperature failure occurs because electric power of the heater lamps is reduced. Therefore, in ACT 10, the control unit 13 carries out normal lamp lighting control.

If the recording medium is the plain paper (YES in ACT 04), in ACT 05, the control unit 13 checks whether a size (an area) of the recording medium is equal to or smaller than A4 or equal to or smaller than LT (a letter size). It depends on the image forming apparatus 101 whether the size equal to or smaller than A4 or the size equal to or smaller than LT is adopted.

If the recoding medium is not equal to or smaller than the predetermined size (NO in ACT 05), a heat release amount is large. Therefore, it is likely that a fixing temperature failure occurs because the electric power of the heater lamps is reduced. Therefore, in ACT 10, the control unit 13 carries out the normal lamp lighting control in the print operation.

If the recording medium is equal to or smaller than the predetermined size (YES in ACT 05), in ACT 06, the control unit 13 checks whether a state of the print meets a predetermined condition. That is, the control unit 13 checks whether the state of the print satisfies any one of (1) timing when a predetermined time (X seconds) elapses after a print start, (2) timing when the predetermined time (X seconds) elapses after the print start and the heating roller 91 temperature is equal to or higher than a predetermined temperature (Y° C.), (3) timing when a predetermine number (Z) or more of recording media are subjected to fixing after the print start, and (4) timing when at least two of (1) to (3) hold. The respective constants can be set as, for example, X=15 seconds, Y=160° C., and Z=10.

If the state of the print does not meet the predetermined condition (NO in ACT 06), it is likely that a fixing temperature failure occurs because the control in this embodiment is executed. Therefore, in ACT 10, the control unit 13 carries out the normal lamp lighting control.

If the state of the print does not meet the predetermined condition (YES in ACT 06), in ACT 07, the control unit 13 executes a lamp lighting curtailing control in this embodiment in the print operation.

It is also possible to add processing to the flow shown in FIG. 10, check whether image forming processing for a full-color image with a thick toner layer is performed, if the image forming processing for the full-color image is performed, carry out the normal lamp lighting control, and, if the image forming processing for the full-color image is not performed, execute the lamp lighting curtailing control in this embodiment.

If sizes and types of recording media are mixed, the processing in ACTS 04 to 10 may be repeatedly executed for each of the recording media to be printed.

With the image forming apparatus in this embodiment explained above, it is possible to reduce power consumption of the fixing device without causing a fixing temperature failure. In the lamp lighting control in this embodiment, it is possible to easily control a reduction rate of power consumption. Therefore, it is possible to attain an appropriate reduction in electric power while flexibly coping with the specifications of the image forming apparatus 101.

The functions explained in the embodiment may be configured using hardware. Alternatively, the functions may be realized by causing a computer to read a program describing the functions using software. The functions may be configured by selecting the software or the hardware as appropriate.

Further, the functions can be realized by causing a computer to read a program stored in a not-shown recording medium. A recording form of the recording medium in this embodiment may be any form as long as the recording medium is a recording medium that can record the program and can be read by the computer.

The present invention is not limited to the embodiment per se. In an implementation stage, the constituent elements can be modified and embodied without departing from the spirit of the present invention.

Various inventions can be formed by appropriate combinations of the plurality of constituent elements disclosed in the embodiment. For example, several constituent elements may be deleted from all the constituent elements described in the embodiment. Further, the constituent elements described in different embodiments may be combined as appropriate.

What is claimed is:

1. An image forming apparatus comprising:
an image forming unit configured to form a toner image on a recording medium;
a heating unit and a pressurizing unit functioning as heating and pressurizing members provided in a fixing unit;
a first heater provided on an inside of the heating unit and configured to heat a center of the heating unit;
a second heater provided on the inside of the heating unit and configured to heat a peripheral section of the heating unit; and
a control unit configured to alternately repeat a heating state and a non-heating state for the respective heaters and heat the heating unit, wherein
the control unit alternately subjects the first and second heaters to heating control such that any one of the first and second heaters is in the heated state and, if a predetermined condition holds, sets a heating time of at least one heater shorter than a heating time during the alternate heating control and controls the first and second heaters such that any one of the first and second heaters is in the heating state or both of the first and second heaters are in the non-heating state.

2. The apparatus according to claim 1, wherein the predetermined condition is to satisfy all following conditions (1) to (3):
a condition (1) that thickness or basis weight of the recording medium is equal to or smaller than a first predetermined value;
a condition (2) that an area of the recording medium is equal to or smaller than a second predetermined value; and
a condition (3) that the image forming apparatus is performing a print operation and is in a predetermined state.

3. The apparatus according to claim 2, wherein the predetermined state is any one of following states (1) to (4):
a state (1) in which a predetermined time elapses after a print start;
a state (2) in which the predetermined time elapses after the print start and a heating unit temperature is equal to or higher than a predetermined temperature;
a state (3) in which a predetermined number or more of recording media are subjected to fixing after the print start; and
a state (4) in which at least two of the states (1) to (3) hold.

4. The apparatus according to claim 2, wherein the predetermined condition further satisfies a condition (4):
a condition (4) that a toner image formed on the recording medium is not a full-color image.

5. The apparatus according to claim 1, wherein, if the predetermined condition does not hold, the control unit equalizes time of the heating state and time of the non-heating state of the respective heaters.
